(19) United States
(12) Patent Application Publication
(10) Pub. No.: US 2020/0073146 A1
(43) Pub. Date: Mar. 5, 2020

(54) Generic Reading Glasses with Convergence Assistance

(71) Applicant: Jan Hoogland, Carmel, CA (US)

(72) Inventor: Jan Hoogland, Carmel, CA (US)

(21) Appl. No.: 16/122,873

(22) Filed: Sep. 5, 2018

(51) Int. Cl. G02C 7/06

(52) U.S. Cl. CPC G02C 7/06; G02C 2202/10

(57) ABSTRACT

Binocular instruments are designed to present images to unaccommodated normal eyes. The eyes are then at their rest position, at which the eyes are focused at infinity and have zero convergence, approximately. Also, custom prescriptions by optometrists prescribe glasses that provide vision correction for unaccommodated eyes. Current generic reading glasses and generic bi-, multi and varifocal additions to custom prescription glasses however lack convergence assistance that provides unaccommodated or partially accommodated vision. Current technology provides convergence assistance by means of prism power which can be applied to current generic reading glasses. The present invention provides generic reading glasses with focusing assistance and convergence assistance. The present invention also provides generic bi-, multi- and varifocal additions for custom prescription glasses with focusing assistance and convergence assistance.

### CROSS-REFERENCE TO RELATED APPLICATIONS

KNIGHT, SAM, “The spectacular power of Big Lens”, The Guardian, May 10, 2018 article: https://www.theguardian.com/news/2018/may/10/the-invisible-power-of-big-glasses-eyewear-industry-essilor-luxottica
SMITH, GEORGE (University of Melbourne) & ATCHISON, DAVID A. (Queensland University of Technology), 1997, Cambridge University Press, The Eye and Visual Optical Instruments: https://www.cambridge.org/core/books/the-eye-and-visual-optical-instruments/910C5FCCC5EBA1A81B08C68C3DA3CFFB

### BACKGROUND OF THE INVENTION

Vision is a very precious possession. The quality of our vision is such that what we see we consider to be reality, in contrast to any other image that mankind is able to produce. It is very difficult to imagine that what we see is actually just an image projected in our brain.

The image is exceedingly wide-angled, has depth perception, is perfectly color-corrected and is of high resolution. It is stabilized, varifocal and is able to fuse the two images provided by the two eyes into a single image. All this has been achieved with the use of a single lens element per eye, giving the human optical designer pause. On the other hand, human vision is affected by the imperfections of this world. In many cases aberrations, like lack of focus, astigmatism and misalignment are in need of correction. This situation makes it worthwhile to consider how we can best accommodate the vision imperfections in the design of optical instrumentation. And, if so desired or needed, how we can best assist the accommodation ability of our vision.

An optometrist provides a custom prescription for the correction of the above-mentioned aberrations. This prescription is valid for unaccommodated eyes, that is for eyes in their rest position. The eyes are then focused at infinity and their convergence is zero, approximately. The correction prescribed by the optometrist is also valid for reading distances because focusing does not incur any change in the aberrations. No further testing by the optometrist is required for current bifocal glasses. The user decides only on the strength of the desired focal assistance.

In addition to the custom prescription by the optometrist, there is a large class of optical instruments that assists humans in seeing more and better, like microscopes and binoculars. Also, these instruments are basically designed to deliver their images to unaccommodated eyes. Although the eyes are varifocal, they are focused at infinity in the unaccommodated position.

Eyes have very large angle of view. Yet, their convergence is closely controlled, that is the relative alignment of their visual axes. In order to observe close objects, the two images formed by the two eyes must coincide. This is accomplished by convergence of the visual axes of the eyes at the object. One reason for keeping the relative alignment under tight control is that only a small part of the retina, called the fovea, provides high resolution. Normal eyes at their rest position keep the visual axes centered on the fovea area. Note that the visual axes of the eyes do not coincide with the optical axes. They are separated by a few degrees.

The alignment of the eyes in the unaccommodated position can be demonstrated by alternately opening one eye at a time. If the object is close, a separation of the two images can be observed, due to the separation of the two eyes. When both eyes are opened this separation is quickly eliminated by the brain by turning the eyes towards each other. Nevertheless, it is important to note the existence of a definite unaccommodated position of the eyes. It is the position at which normal eyes are at rest, are focused at infinity and the convergence is zero, approximately. The visual axes are then parallel and centered on the fovea. Binocular instruments therefore generally provide images to unaccommodated eyes. Also, the optometrist prescribes custom glasses for this position. Unaccommodated eyes serve all day long without experiencing any strain or fatigue.

However, when observing close objects, like reading a book, the eyes have to accommodate the situation in two ways. Reading requires considerable focusing effort but also considerable converging effort of the visual axes. Both efforts are sizeable and large compared to the accuracy required for the formation of a clear image. From here on this condition will be called the reading mode. It includes all situations in which objects are close. The pronounced preference of the eyes for their unaccommodated position also indicates that the reading mode takes considerable effort. Yet, the eyes are well-equipped to deal with the reading mode as young readers can testify.

However, the ubiquitous use of reading glasses indicates the need for reading assistance. Reading glasses are used for comfortable reading, for watching electronic displays, for special working conditions as well as for older people with limited eye flexibility. Current reading glasses provide focal assistance to allow the eyes to observe written matter while focused near infinity. But the eyes still have to provide the necessary convergence of the visual axes in order to obtain coincidence of the two images produced by the two eyes. Although the brain makes the correction very quickly, which is rarely observed by the user, the required effort is nevertheless considerable.

Cases that require focal assistance may naturally be expected to need convergence assistance as well. Convergence assistance may not always be essential for reading glasses but it will always further relax the eyes, whether noticed, appreciated or not. Several reasons exist that this convergence is not provided by current reading glasses. The operation directed by the brain is so quick that it is rarely observed. Also, the incorporation of convergence assistance in generic reading glasses used to be technically difficult. And the rubbing of the eyes after an hour of intense close-up observation does not indicate the cause of it. Once convergence assistance is tried, it will be greatly appreciated.

With modern technology, producing generic reading glasses that provide convergence assistance in addition to focus assistance can be accomplished at a relatively small additional expense. These new generic prism reading glasses present written material to the unaccommodated eyes, that is to eyes in their rest position. This new type of reading assistance can also be provided in a partial measure, if so desired. The claims leave the amount of assistance open.

### BRIEF SUMMARY OF THE INVENTION

A pair of eyes have a definite rest position at which they are focused at infinity and have their visual axes parallel. In this position they perform tirelessly all day.

Close-up conditions however require the eyes to provide focal adjustment as well as convergence of their visual axes in order to cause the two images to coincide. Current generic reading glasses and the generic bifocal part of prescription glasses only provide focal assistance. The present invention provides generic reading glasses and the generic bifocal part of prescription glasses with focal assistance combined with convergence assistance in order to provide a significantly improved and more restful reading experience.

### BRIEF DESCRIPTION OF THE DRAWINGS

FIG. 1 shows a pair of normal eyes in their unaccommodated position, that is when the eyes are at rest. In this position the eyes are focused at infinity and have zero convergence, approximately. Their visual axes are then parallel and centered on the fovea. Normal vision is considered a vision that allows to pass a test such as required for a driver's license and is not significantly improved by a custom prescription of an optometrist. The eyes assume this position whenever they are at rest. The eyes provide vision all day long without any eye strain. Note that the visual axis of the eye is separated from the optical axis by a few degrees.

FIG. 2 shows normal eyes in a position in which they focus on a close object but have not yet undergone the convergence adjustment by the brain. This position may be observed by alternatively closing one of the eyes while watching a close object. Note that the brain is presented with two images that require exact coincidence for the image to be useful.

FIG. 3 shows normal eyes after the brain has been allowed to converge the visual axes by turning the eyes toward each other. It illustrates the needed convergence effort. High accuracy is required in order to be able to observe to the limit of the eye resolution.

FIG. 4 shows normal eyes in their rest position and as presented with current reading glasses while preventing the brain to converge the visual axes. It shows that the brain is presented with two images that the eye convergence needs to put together. Note that the light rays enter the eyes parallel and that the visual axes are approximately parallel.

FIG. 5 illustrates the current state of reading glasses. It shows normal eyes with current reading glasses after allowing the brain to put the two images together. It shows how large the necessary convergence is compared to the required accuracy necessary for accurate observation, which is a small part of a letter. It presents the present state, that is the prior the art, of reading glasses. The rays entering the eye are still parallel, but the visual axes are converged towards each other.

FIG. 6 illustrates claim 1. It shows the position of the unaccommodated eyes while the converging prism reading glasses provide focus as well as convergence. The provided convergence matches the focusing power in that both efforts are needed to put the eyes in the unaccommodated state, approximately. Note that the rays enter the eyes parallel and that the visual axes are also parallel and centered on the fovea. The amount of provided convergence does not necessarily need to match the focusing power as the eyes will make up the difference. A partial convergence assistance still reduces the eye strain, in the same way that conventional glasses can be used to partially assist the focusing effort of the eyes. The claim leaves the amount of assistance open.

FIG. 7 illustrates claim 3. It is similar to FIG. 6 except that the distribution of the total prism power is different. As long as the sum of the prism power equals the desired total, the convergence power is the same. Only a small displacement of the object with respect to the nose occurs.

FIG. 8 shows the vision situation of the large group of people with eyes that have refractive errors, like focal errors and astigmatism. They need custom prescription glasses in order to improve their vision to become comparable with normal vision. When equipped with custom glasses their vision becomes normal. Their eyes are then in their rest position and provide a focus near infinity. Their visual axes are centered on their respective fovea but are not necessarily parallel.

FIG. 9 shows, in comparison with FIG. 3, that those wearing custom prescription glasses generally have the same reading ability as those with normal eyes. Their custom prescription glasses compensate the focal errors of the eyes.

FIG. 10 is similar to FIG. 4. The eyes with focal errors are equipped with custom prescription glasses that have obtained focal reading assistance in the form of bifocal lens elements. The brain has been prevented from putting the two images together, for example by means of alternatively closing one eye. It shows the effort needed to converge the two images by converging the visual axes toward each other.

FIG. 11 illustrates the current state of bifocal lens addition to prescription glasses. It shows the position of the eyes with focal errors after the brain has been allowed to bring the two images together by convergence of the visual axes. Note that after exiting from the current generic bifocal lens element the rays are parallel, but the visual axes of the eyes must converge. The drawing shows the prior art of bi-multi- and varifocal lens elements in prescription glasses.

FIG. 12 illustrates claim 2. It shows the position of the eyes with focal errors after generic prism power has been added to the bifocal lens element. The eyes are now in their rest position while reading. The generic prism function and the generic bifocal focus function can now be fused with the custom prescription lens into a single piece of optical material. The light rays between the bifocal element and the prescription glasses are parallel. The visual axes are centered on the fovea but not necessarily parallel. In the same way that the amount of focusing assistance provided by conventional reading glasses can be partial, the amount of convergence assistance can be partial also. The claim leaves the amount of assistance open.

FIG. 13 illustrates claim 4. It shows that the distribution of the convergence assistance is independent of the location as long as the sum remains as desired. Note that the situation of both eyes is still the same as their situation in FIG. 12. The eyes combined with the custom prescription glasses are focused at infinity, approximately. The visual axes are centered on the fovea, but not necessarily parallel.

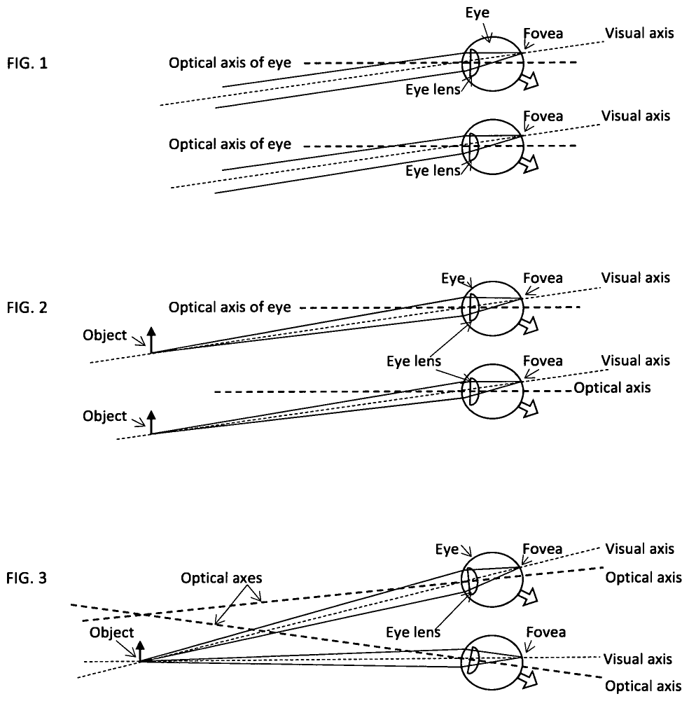

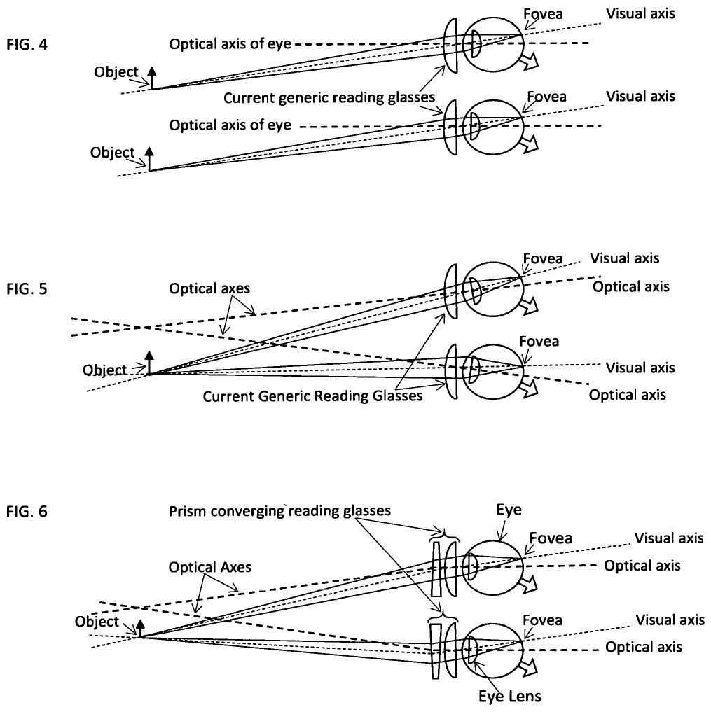

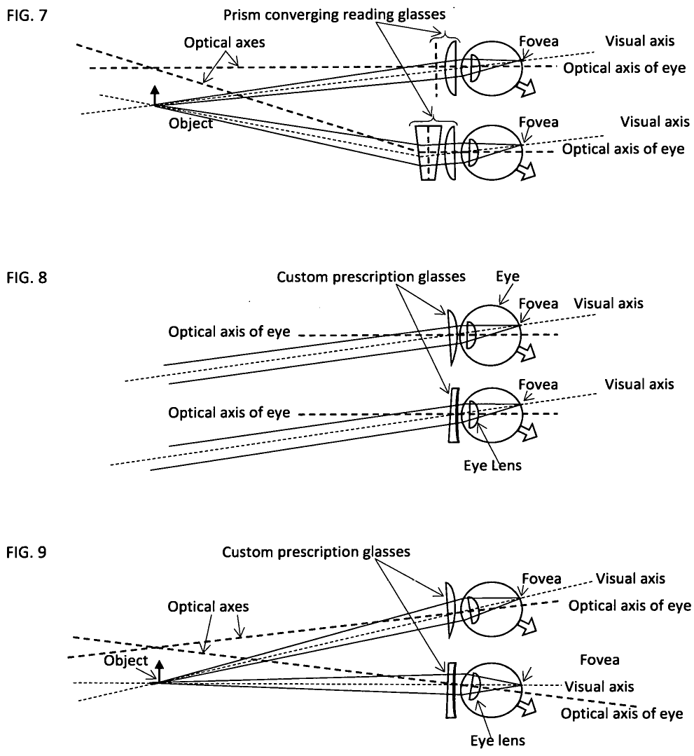

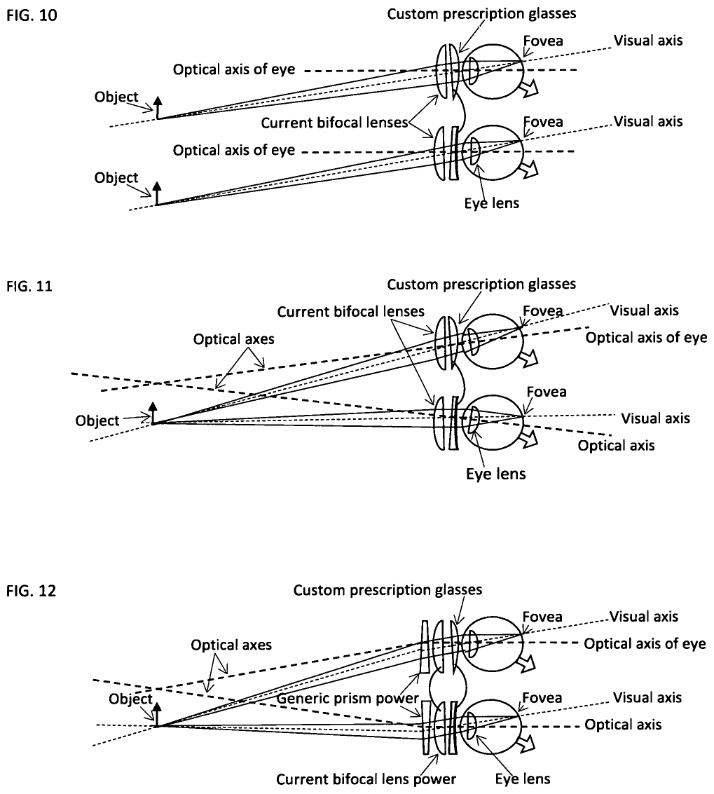

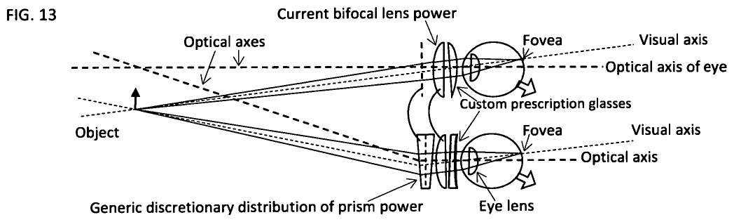

### DETAILED DESCRIPTION OF THE INVENTION

A pair of normal eyes have a definite rest position. They are then focused at infinity and their visual axes are parallel, approximately. In this position they perform tirelessly all day, without showing any strain.

This situation is recognized by optical instrument designers so that their binocular instruments generally provide at least a pair of images that are focused at infinity and have parallel optical axes, approximately.

Close-up conditions however require considerable effort from the eyes in two ways. First, the eyes have to provide focal adjustment and, second, the eyes have to provide convergence in order to cause the two images to coincide at the very point of observation. These efforts are substantial for optimal observation and are continually changing. The depth of focus of vision is about 0.4 diopter while a reading distance of 13 inches requires 3 diopters of additional focal power, which amounts to an 8× ratio. A reading distance of 13 inches requires a convergence of the visual axes of about 5 degrees while the resolution ability of the eye is 1/60 of a degree, which amounts to a 300× ratio. Maintaining high convergence accuracy while continuously changing the subject matter, as is the case with reading, is likely to cause considerable strain, more so than the relatively relaxed focal accuracy requirement.

It is therefore important to add convergence assistance to reading glasses. The amount of convergence assistance can be commensurate with the optical power of the reading glasses and can thus be added on a generic basis. The present invention claims generic reading glasses which provide focal assistance combined with convergence assistance. The claim includes the generic addition of convergence assistance to the bifocal parts of prescription glasses.

1-4. (canceled)

5. An eyeglass device comprising:
an eyeglass frame; and
two lenses mounted to the eyeglass frame, wherein prism powers of the two lenses are selected to allow eyes of the user to converge on objects at a selected reading distance when the eyes are in a rest position, wherein focal powers of the two lenses are selected to allow eyes of the user to image objects at the selected reading distance when the eyes are in the rest position, wherein the focal powers and the prism powers of the two lenses are fixed.

6. The eyeglass device of claim 5, wherein the prism powers of two lenses have a common magnitude and opposite directions.

7. The eyeglass device of claim 5, wherein the prism powers of the two lenses differ in at least one of magnitude or direction, wherein the prism powers of the two lenses in combination are selected to allow the eyes to converge on the object at the selected reading distance when the eyes are in the rest position.

8. The eyeglass device of claim 5, wherein the focal powers of two lenses have a common magnitude.

9. The eyeglass device of claim 5, wherein the focal powers of two lenses have different magnitudes to compensate for focal error in at least one of the eyes.

10. The eyeglass device of claim 5, wherein at least one of the two lenses further includes astigmatism correction.

11. The eyeglass device of claim 5, wherein at least one of the two lenses comprises:
at least one of a bi-focal, multi-focal, or a vari-focal lens.

12. An eyeglass apparatus comprising:
an eyeglass frame; and
two lenses mounted to the eyeglass frame, wherein focal powers of the two lenses are selected to allow the eyes of the user to focus on objects at a selected reading distance when the eyes are in a rest position, wherein each of the two lenses has a positive focal power less than approximately 3 diopters, wherein prism powers of the two lenses are selected to allow the eyes of the user to converge on objects at a selected convergence distance from the eyes when the eyes are in a rest position, wherein the focal powers and the prism powers of the two lenses are fixed.

13. The eyeglass device of claim 12, wherein the focal powers of the two lenses are equal.

14. The eyeglass device of claim 12, wherein the selected convergence distance and the selected reading distance are equal.

15. The eyeglass device of claim 12, wherein the selected convergence distance is greater than the selected reading distance to provide partial convergence assistance.

16. The eyeglass device of claim 12, wherein the prism powers of two lenses have a common magnitude and opposite directions.

17. The eyeglass device of claim 12, wherein the prism powers of the two lenses differ in at least one of magnitude or direction, wherein the prism powers of the two lenses are selected in combination to allow the eyes of the user to converge on objects at the selected convergence distance when the eyes are in the rest position.

18. The eyeglass device of claim 12, wherein at least one of the two lenses further includes astigmatism correction.

19. The eyeglass device of claim 12, wherein at least one of the two lenses comprises:
at least one of a bi-focal, multi-focal, or a vari-focal lens.

20. A prescription eyeglass apparatus comprising:
an eyeglass frame; and
two lenses mounted to the eyeglass frame, wherein focal powers of the two lenses are selected based on a known focal error in at least one eye of a user to allow the eyes of the user to focus on objects at a selected reading distance when the eyes are in the rest position, wherein prism powers of the two lenses are selected to allow the eyes of the user to converge on objects at a selected convergence distance when the eyes are in the rest position, wherein the focal powers and the prism powers of the two lenses are fixed.

21. The prescription eyeglass device of claim 20, wherein the selected convergence distance and the selected reading distance are equal.

22. The prescription eyeglass device of claim 20, wherein the selected convergence distance is greater than the selected reading distance to provide partial convergence assistance.

23. The prescription eyeglass device of claim 20, wherein at least one of the two lenses further includes astigmatism correction.

24. The prescription eyeglass device of claim 20, wherein at least one of the two lenses comprises:
at least one of a bi-focal, multi-focal, or a vari-focal lens.
